(19) United States
(12) Patent Application Publication
(10) Pub. No.: US 2017/0106814 A1
(43) Pub. Date: Apr. 20, 2017

(54) LICENSE PLATE PROTECTOR

(71) Applicant: Darrell Allen, Upper Marlboro, MD (US)

(72) Inventor: Darrell Allen, Upper Marlboro, MD (US)

(21) Appl. No.: 15/330,586

(22) Filed: Oct. 17, 2016

Related U.S. Application Data
(60) Provisional application No. 62/284,956, filed on Oct. 15, 2015.

(51) Int. Cl. B60R 13/10

(52) U.S. Cl. CPC B60R 13/105

(57) ABSTRACT

The License Plate Protectors purpose is to protect the License Plate from all sorts of debri, snow, ice, mud build-up and unwanted pictures.

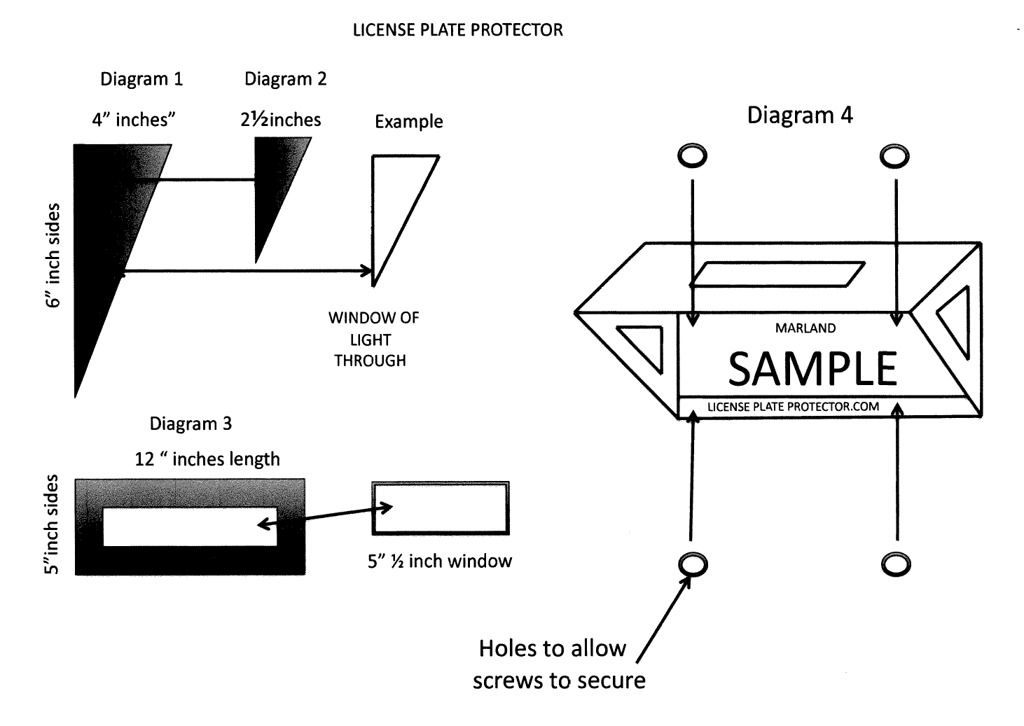

### BACKGROUND OF THE INVENTION

I came about this idea when the snow and ice was stacked up on the back of my pickup truck. It was very hard to remove, the ice was so hard that I twisted my wrist trying to take it off. Using my pickup truck all the time it was a very wintery day with snow and ice and I forgot to put up the tailgate of the back of my pickup truck and realized I just created a lid to block the debri and ice from building up on my license plate, and maybe I can use this idea for cars, trucks, vans, buses etc., also unwanted pictures.

### SUMMARY OF THE INVENTION

Made of high-end impact plastic, molded to fit around 100% of US License Plate Tags. It is a plastic cover with porch light frame around the License plate to protect tags from debris, snow, mud build-up and unwanted pictures.

With triangle sides extending between 2½ to 4 inches on both sides. A Rooftop between 2½ and 3½ inches with a lip overlapping at 2 cm, the length is 11¾ inches. The whole entire molding could have the four holes standard tag installment or the four holes screwed in. Manufacturing cost is $1.75 and if light holes are required on the side or top half the cost would be $2.50. The bottom layer can be constructed of flash mirror plastic.

### DESCRIPTION OF DRAWINGS

1. Diagram 1: 6″ inches and to fit around the license plate triangle side with a 2½ inches triangle window as shown in diagram 1.

2. Diamgram 2: 2½ inch triangle window cut inside of sides to allow light to pass through also this could be any dimension. See diagram 2.

3. Diagram 3: The roof of 12 inches 2 centimeters length and a 4 inch top or shelf. US standerd size license plate with a 5½ inches rectangle window so light can pass through the center of the roof.

4. Diagram 4: The license plate protector has a frame that's built around the license plate with four holes to screw standard U.S license plate dimensions.

The license plate protector can be modified to fit any tags of license plate.

### DESCRIPTION OF THE INVENTION

The frame will have logo or .com in the middle of the bottom casing LicensePlate Protector.

The frame could be completed in high impact plastic or molded. The frame could be molded into high impact plastic, low impact plastic, wood or metal.

1. My invention is based on protecting the license plate from debri, build up of ice and unwanted pictures. It is made of high-end impact plastic, molded to fit around 100% of US License Plate Tags. With triangle sides extending between 2½ to 4 inches on both sides. A rooftop between 2½ and 3½ inches with a lip overlapping at 2 cm, the length is 11¾ inches. The whole entire molding could have the four holes standard tag installation or the four holes screwed in. The manufacturing cost is $1.75 and if light holes are required on the side or top half the cost would be $2.50. The bottom layer can be constructed of flash mirror plastic. The frame could be completed in high impact plastic or molded. The frame could be molded into high impact plastic, low impact plastic, wood or metal.
